(19) United States
(12) Patent Application Publication
(10) Pub. No.: US 2020/0133032 A1
(43) Pub. Date: Apr. 30, 2020

(54) Glasses with Removable Eye Shields

(71) Applicant: Jui-Chi Li, Tainan (TW)

(72) Inventor: Jui-Chi Li, Tainan (TW)

(21) Appl. No.: 16/664,764

(22) Filed: Oct. 25, 2019

(30) Foreign Application Priority Data
Oct. 25, 2018 (TW) 107214520

(51) Int. Cl. G02C 11/00

(52) U.S. Cl. CPC G02C 11/12

(57) ABSTRACT

Eyewear for releasably receiving a shield has a snap-fit mechanism for holding the shield in place.

### BACKGROUND OF THE INVENTION

The present invention relates to eyewear and more particularly to an eyewear frame where it is relatively simple and easy to replace the one or more eyes shields held by the eyewear frame.

It is very common for eyewear frames to have eye shields mounted on the temple arms to protect the eyes of the wearer. The eye shields can block light or flying objects. While threaded fasteners can be used to make a secure connection between the temple arms and the shields, such fasteners generally require the use of a special driver not commonly found as the threaded fasteners are generally very small. The threaded fasteners are also prone to stripping if the frame portions are opened and closed often. Thus, it is typical in frames that are designed to be used with interchangeable shields to not use threaded fasteners to join the shields to the frame.

The present invention provides a new and unique arrangement of frame parts to securely hold one or more shields of the eyewear in place in the frame.

### SUMMARY OF THE INVENTION

It is an object of the present invention to provide an eyewear frame which can hold a shield in place or allow the shield to be released from the frame by means of a snap-fit operation. The present invention allows for the secure engagement of the shield with the frame while allowing for the easy removal of the shield without the need of special tools.

In one preferred embodiment of the present invention, the frame holds at least one shield, and the shield is releasably coupled to the frame. A tab on the shield and a notch in the temple arm are formed with corresponding recesses and protrusions that interlock with each other to lock the shield in place.

In a preferred embodiment of the invention, the tab and the temple are are provided with corresponding convex portions and concave portions that interlock with each other when the tab engages the notch in the temple arm.

In a preferred embodiment of the invention, one of the tab and the temple arm is provided with one or more fin members, and the other of the temple arm is provided with a track that corresponds to the one or more fins to prevent outer and inner movement of the shield with respect to the temple arm.

### BRIEF DESCRIPTION OF THE DRAWINGS

FIG. 1 is a perspective view of the temple arm and the side shield of eyewear incorporating the present invention. The side shield is shown removed from the temple arm.

FIG. 2 is a side view of the temple arm and the side shield of eyewear incorporating the present invention. The side shield is shown removed from the temple arm.

FIG. 3 is a side view of the temple arm and the side shield of eyewear incorporating the present invention. The side shield is shown inserted into the temple arm.

FIG. 4 is a perspective view of the temple arm and the side shield of eyewear incorporating the present invention. The side shield is shown inserted into the temple arm.

FIG. 5 is a front perspective view of eyewear incorporating the present invention. The front portion of the frame of the eyewear is shown in dotted lines.

### DETAILED DESCRIPTION OF THE PREFERRED EMBODIMENT

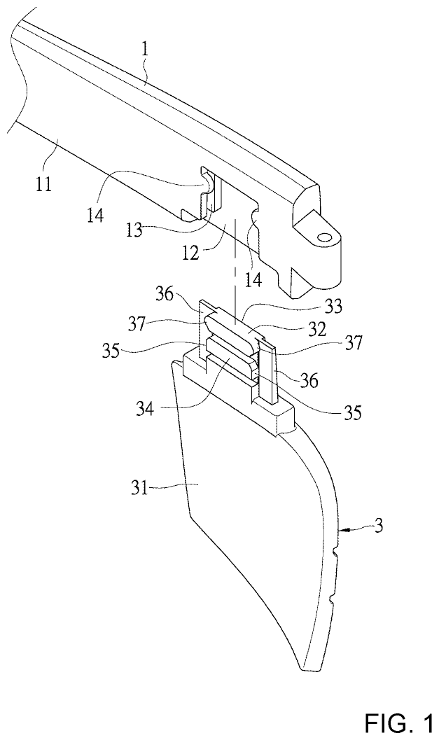

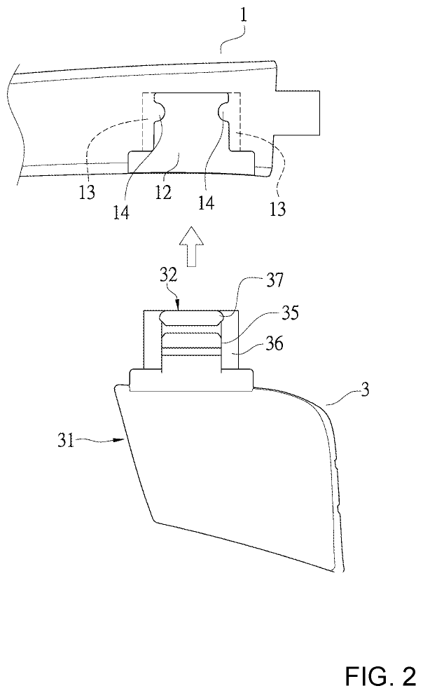

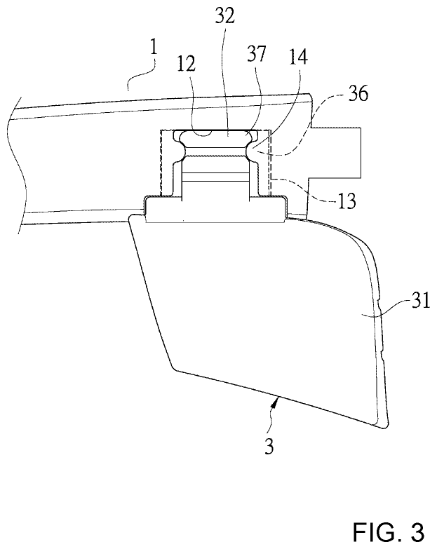

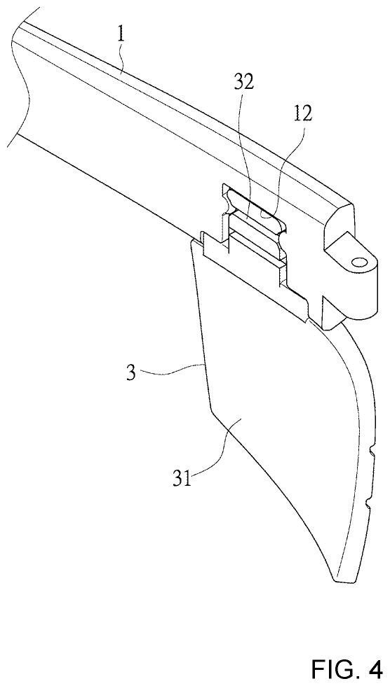

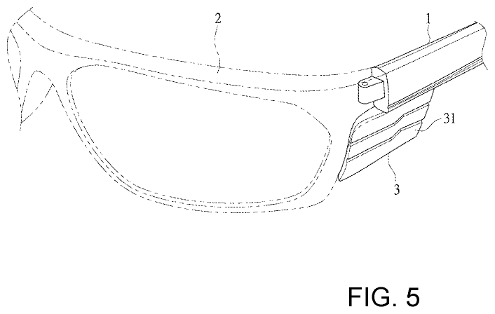

As shown in FIGS. 1-5, in one embodiment of the present invention, the eyewear of the present invention can have two corresponding left and right orbitals that make up the front portion of the frame 2. Each of the orbitals can have an opening in which a lens is placed or inserted. In the embodiments of FIGS. 1-7, the orbitals surround the outer portion of the lens. The orbitals are made up of an upper brow portion and a lower cheek portion. An inner groove is form in the orbital to hold the lens in place. The inner groove is formed on the underside of the upper brow portion and on the upper side of the lower cheek portion.

As shown in FIG. 1, a temple arm 1 can be joined to the front portion of the frame 2. This joinder can be through a hinge pin that is inserted through an opening in the temple arm 1 and openings in the front portion of the frame 2. In the figures, only the left temple arm and shield are shown. The same mechanism is used with the right temple arm, and for the sake of brevity is not described here.

The shield 3 that fits with the temple arm 1 is formed with tab 32 preferably on the upper side of the shield 3. The tab 32 extends upwardly from the shield 3. The shield is typically formed to closely engage the lower surface of the temple arm 1. The tab 32 engages a notch 12 in the temple arm 1. As shown in FIG. 1, the notch 12 is open to the exterior of the temple arm 1 at the lower surface of the temple arm and the inner surface 11 of the temple arm. As shown in FIG. 1, the notch does not extend to the upper surface of the temple arm. The notch also does not extend to the outer surface of the temple arm. In this manner the joining mechanism is mostly hidden from view when the shield is attached to the temple arm 1 and the eyewear is positioned on the head of the wearer.

The shield 3 has an inner surface 31 that is disposed facing the head of the wearer and an outer surface disposed away from the head of the wearer.

As shown in FIG. 1, the temple arm 1 has a notch or opening or indent 12. In the notch 12 are two laterally opposed tracks. The tracks form vertical slots 13. The tracks are formed by an outer wall and an inner wall. As shown in FIG. 1, the inner wall of each track is formed with a protrusion 14 that is rounded and extends laterally and into the notch from each track. For an even more secure connection the outer walls of the tracks could be formed with protrusions 14. As shown in FIG. 1, only one protrusion is formed on each inner wall, but multiple protrusions could be formed on each inner wall. The protrusions 14 could also be offset from each other.

The tab 32 of the shield preferably has an outer surface 33 and an inner surface 34. The tab is also preferably formed with laterally opposed fin extensions 36 that can be received in the space 13 between the tracks in the notch in the temple arm. The fin extensions 36 are preferably tapered, and are thinner at the upper portions than at their lower portions to make it easier to initially insert the tab 32 into the notch 12.

The tab 32 is preferably formed with a central portion that is wider than the fin extensions 36. The wider central portion fits into the space between the inner and outer side walls of the opposed lateral tracks. The wider central portion is preferably formed with upper ribs 37 and lower ribs 35. Preferably, the upper and lower ribs are formed on the inner and outer surfaces of the central portion of the tab. A space is disposed between the upper and lower ribs. The upper and lower ribs are shaped so that the protrusions 14 will be engaged between them with the protrusion partially extending in the space between the ribs. The ends of the ribs are preferably partially rounded to help with the engagement and release of the protrusions 14.

While the protrusions 14 had been described and shown as being disposed on the temple arm 1 and the ribs that receive the protrusions are described and shown as being on the tab 32 of the shield 3 their positions could be reversed. To engage the shield 3 on the temple arm 1, the shield is inserted into the notch 12 so that it is fully engaged in the notch and so that the fin extensions 36 ride in the space 13 in the tracks, and the shoulders 35 and 37 engage the protrusions 14. Preferably, the shoulders engage the protrusion only when the tab is fully inserted into the notch, in this manner the mechanism of the present invention helps to make sure the shield provides the full amount of protection for which it is designed. To remove the shield 3 the user pulls down on the shield with enough force to overcome the snap fit between the shoulders 35 and 37 and the protrusion 14.

The inner surface 34 of the tab is generally flush with the inner surface of the temple arm 11.

I claim:

1. Eyewear comprising:
a frame having for holding at least one lens;
a lens coupled to the frame, the frame having at least one temple arm;
a side shield mounted on the frame; wherein
the side shield is formed with a tab that engages a notch in the temple arm and the notch and the tab being formed with corresponding to recesses and protrusions that interlock with each other when the tab and the notch are fully engaged.
